(19) United States
(12) Patent Application Publication
(10) Pub. No.: US 2008/0152197 A1
(43) Pub. Date: Jun. 26, 2008

(54) INFORMATION PROCESSING APPARATUS AND INFORMATION PROCESSING METHOD

(76) Inventor: Yukihiro KAWADA, Asaki-shi (JP)

Correspondence Address: BIRCH STEWART KOLASCH & BIRCH, PO BOX 747, FALLS CHURCH, VA, 22040-0747, US

(21) Appl. No.: 11/961,324

(22) Filed: Dec. 20, 2007

(30) Foreign Application Priority Data
Dec. 22, 2006 (JP) 2006-346516

(51) Int. Cl. G06K 9/00

(52) U.S. Cl. 382/115

(57) ABSTRACT

An information processing apparatus according to the invention comprises: an image input unit to which an image is input; a face detecting unit which detects a face area of a person from the image input to the image input unit; a face-for-recording selecting unit which selects a desired face area with which a desired voice note is to be associated from among face areas detected by the face detecting unit; a recording unit which records a desired voice note associating the voice note with the face area selected by the face-for-recording selecting unit; a face-for-reproduction selecting unit which selects a desired face area from among face areas with which voice notes area associated by the recording unit; and a reproducing unit which reproduces a voice note associated with the face area selected by the face-for-reproduction selecting unit.

### BACKGROUND OF THE INVENTION

1. Field of the Invention

The present invention relates to recording of information relevant to an image.

2. Description of the Related Art

Japanese Patent Application Laid-Open No. 2004-301894 discloses a technique that recognizes speech inputted as an annotation with a dictionary which is prepared through speech recognition, converts the recognized speech to text data, and associates it with an image.

A technique disclosed in Japanese Patent Application Laid-Open No. 11-282492 extracts faces in order to improve the success rate of speech recognition and also adds an image comparison device which determines the degree of similarity between faces.

With a technique set forth in Japanese Patent Application Laid-Open No. 2003-274388, when objects are detected and the presence of a human being as an object is sensed when collecting information with a monitoring camera, speech is also simultaneously recorded into a database.

### SUMMARY OF THE INVENTION

Although the techniques described above can randomly collect data, they cannot associate audio and/or information which has meaning e.g., a specific note about a specific person, with each person.

It is an object of the present invention to provide a technique that can easily associate a face in an image with arbitrarily input information, such as a voice note and text information, at a low cost.

An information processing apparatus according to a first aspect of the invention comprises: an image input unit to which an image is input; a face detecting unit which detects a face area of a person from the image input to the image input unit; a face-for-recording selecting unit which selects a desired face area with which a desired voice note is to be associated from among face areas detected by the face detecting unit; a recording unit which records a desired voice note associating the voice note with the face area selected by the face-for-recording selecting unit; a face-for-reproduction selecting unit which selects a desired face area from among face areas with which voice notes area is associated by the recording unit; and a reproducing unit which reproduces a voice note associated with the face area selected by the face-for-reproduction selecting unit.

According to the first aspect, it is possible to record a desired voice note in association with a desired face in an image and produce a voice note associated with a desired face.

An information processing apparatus according to a second aspect of the invention comprises: an image input unit to which an image is input; a face detecting unit which detects a face area of a person from the image input to the image input unit; a face-for-recording selecting unit which selects a face area with which desired relevant information is to be associated from among face areas detected by the face detecting unit; a relevant information input unit to which desired relevant information is input; a recording unit which records the relevant information input to the relevant information input unit associating the relevant information with the face area selected by the face-for-recording unit; a face-for-display selecting unit which selects a desired face area from among face areas with which relevant information is associated by the recording unit; and a display unit which displays relevant information associated with the face area selected by the face-for-display selecting unit by superimposing the relevant information at a position appropriate for the position of the selected face area.

According to the second aspect, it is possible to record text information in association with a desired face and display text information associated with a desired face at a position appropriate for the position of the face.

An information processing apparatus according to a third aspect of the invention comprises: an image input unit to which an image is input; a face information input unit to which face information including information identifying a face area in the image input to the image input unit is input; an address information reading unit which reads out address information associated with the face information input to the face information input unit; a display unit which displays the image input to the image input unit with a picture indicating that the address information is associated with the face information; and a transmission unit which transmits the image input to the image input unit to a destination designated by the address information.

According to the third aspect, it is possible to automatically perform the operation of transmitting an image containing a face based on address information associated with the face.

An information processing apparatus according to a fourth aspect of the invention comprises: an image input unit to which an image is input; a face information input unit to which face information including information identifying a face area in the image input to the image input unit is input; a personal information reading unit which reads out personal information associated with the face information input to the face information input unit; a search information input unit to which search information for retrieving desired face information is input; a search unit which retrieves personal information that corresponds with the search information and face information that is associated with the personal information corresponding with the search information by comparing the search information input to the search information input unit with the personal information read out by the personal information reading unit; and a list information generation unit which generates information for displaying a list of personal information and face information retrieved by the search unit.

According to the fourth aspect, it is easy to search for a face with which specific personal information is associated and is possible to automatically create an address book based on list information.

An information processing apparatus according to a fifth aspect of the invention comprises: an image input unit to which an image is input; a face information input unit to which face information including information identifying a face area in the image input to the image input unit is input; a relevant information input unit to which desired relevant information is input; a face selecting unit which selects a desired face area from among face areas in the image input to the image input unit based on the face information input to the face information input unit; a relevant information selecting unit which selects relevant information to associate with the face area selected by the face selecting unit from among pieces of relevant information input to the relevant information input unit; and a recording unit which records the relevant information selected by the relevant information selecting unit associating the relevant information with the face area selected by the face selecting unit.

According to the fifth aspect, it is easy to associate and record relevant information, such as the mail address of the owner of a face.

An information processing method according to a sixth aspect of the invention comprises the steps of: inputting an image; detecting a face area of a person from the inputted image; selecting a desired face area with which a desired voice note is to be associated from among detected face areas; recording a desired voice note associating the voice note with the selected face area; selecting a desired face area from among face areas with which voice notes are associated; and reproducing a voice note associated with the selected face area.

An information processing method according to a seventh aspect of the invention comprises the steps of: inputting an image; detecting a face area of a person from the image input in the image input step; selecting a face area with which desired relevant information is to be associated from among detected face areas; inputting desired relevant information; recording the relevant information input in the relevant information input step associating the relevant information with the selected face area; selecting a desired face area from among face areas with which relevant information is associated; and displaying relevant information associated with selected the face area by superimposing the relevant information at a position appropriate for the position of the selected face area.

An information processing method according to an eighth aspect of the invention comprises the steps of: inputting an image; inputting face information including information identifying a face area in an image input in the image input step; reading out address information associated with the inputted face information; displaying the inputted image with a picture indicating that the address information is associated with the face information; and transmitting the image input in the image input step to a destination designated by the address information.

An information processing method according to a ninth aspect of the invention comprises the steps of: inputting an image; inputting face information including information identifying a face area in the image input in the image input step; reading out personal information associated with the inputted face information; inputting search information for retrieving desired face information; retrieving personal information that corresponds with the search information and face information that is associated with the personal information corresponding with the search information by comparing the inputted search information with the personal information read out; and generating information for displaying a list of retrieved personal information and face information.

An information processing method according to a tenth aspect of the invention comprises the steps of: inputting an image; inputting face information including information identifying a face area in the inputted image; inputting desired relevant information; selecting a desired face area from among face areas in the inputted image based on the inputted face information; selecting relevant information to associate with the selected face area from among inputted pieces of relevant information; and recording the selected relevant information associating the selected relevant information with the selected face area.

The present invention allows selection of a desired face area from detected face areas and facilitates association of the selected face in an image with arbitrarily inputted information, such as a voice note and text information.

### BRIEF DESCRIPTION OF THE DRAWINGS

FIG. 1 is a block diagram of an information recording apparatus according to a first embodiment;

FIGS. 2A and 2B are flowcharts illustrating the flow of recording processing;

FIG. 3 illustrates detection of face areas;

FIG. 4 illustrates a concept of face information;

FIG. 5 shows a table that associates an address at which face information is stored in a non-image portion of an image file, the identification number of a face, and the position of the face, with the file name of a voice note;

FIG. 6 illustrates recording of the table and audio files of voice notes in a non-image portion of an image file;

FIG. 7 illustrates recording of an audio file separate from the image file in a recording medium;

FIG. 8 illustrates including of the identification number (face number) of a face area in a portion of the file name of each audio file;

FIG. 9 illustrates recording of a table itself that associates identification information (file name) of image files and face information in the image files with identification information (file name) of voice notes in the recording medium as a separate file;

FIG. 10 is a flowchart illustrating the flow of reproduction processing;

FIG. 11 illustrates superimposition of voice note marks which are placed near face areas;

FIG. 12 illustrates enlarged display of a selected face area with a voice note mark;

FIG. 13 is a block diagram of an information recording apparatus according to a second embodiment;

FIGS. 14A and 14B are flowcharts illustrating the flow of recording processing;

FIG. 15 illustrates recording of a table that associates face information with personal business card information in the recording medium as a separate file;

FIG. 16 shows an example of a text file written in Vcard (Electronic Business Card);

FIG. 17 is a flowchart illustrating the flow of reproduction processing;

FIG. 18 illustrates association of personal business card information with specific face areas;

FIG. 19 illustrates superimposition of icons near the face areas;

FIG. 20 illustrates enlarged display of a face area and icons;

FIG. 21 illustrates change of detailed item display to name, address, and telephone number;

FIG. 22 is a block diagram of an information recording apparatus according to a third embodiment;

FIG. 23 is a flowchart illustrating the flow of mail transmission processing;

FIG. 24 is a block diagram of an information recording apparatus according to a fourth embodiment;

FIG. 25 is a flowchart illustrating the flow of search and display processing;

FIG. 26 illustrates display of a list of people relevant to “Reunion 0831”;

FIG. 27 is a flowchart illustrating the flow of search and output processing;

FIG. 28 is a block diagram showing an internal configuration of an image recording apparatus according to a fifth embodiment;

FIG. 29 is a flowchart illustrating the flow of information setting processing;

FIG. 30 shows an example of personal information written in a table format;

FIG. 31 shows display of boxes around face areas;

FIG. 32 illustrates listed display of personal information near an enlarged image of a selected face area;

FIG. 33 illustrates display of a selected person's name and address;

FIG. 34 shows a table in which specific personal information is associated with specific face information; and

FIG. 35 shows examples of the reference position coordinates and sizes of face areas.

### DETAILED DESCRIPTION OF THE PREFERRED EMBODIMENTS

Preferred embodiments of the invention will be described with reference to attached drawings,

### First Embodiment

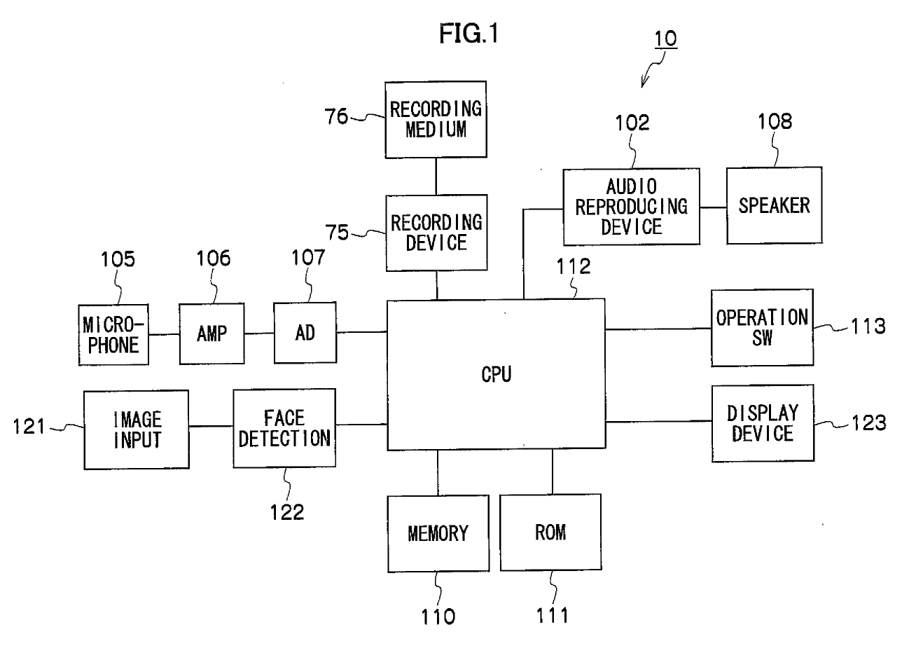

FIG. 1 is a block diagram of an information recording apparatus 10 according to a preferred embodiment of the invention.

A microphone 105 collects sound and converts the sound to an analog audio signal.

An amplifier (AMP) 106 amplifies the analog signal input from the microphone 105. The amplification factor thereof is changed through control of voltage.

The amplified analog audio signal is sent to an A/D conversion unit 107, in which the signal is converted to a digital audio signal, and sent to a recording device 75.

The recording device 75 compresses the digital audio signal by a predetermined method (e.g., MP3) and records it on a recording medium 76.

An audio reproducing device 102 converts digital audio data supplied from the A/D conversion unit 107 or digital audio data read out from the recording medium 76 and reconstructed by the recording device 75 into an analog audio signal, and outputs it to a speaker 108.

Processing blocks involved in the audio recording and reproducing operations described above are collectively represented as an audio system.

An image input unit 121 is composed of an image pickup element, an analog front-end circuit, an image processing circuit and so on, and it converts a subject image into image data and inputs the image data to a face detecting unit 122.

The face detecting unit 122 detects a face area, which is an area containing a person's face, from image data input from the image input unit 121. For the method for detecting face areas, the technique disclosed in Japanese Patent Application Laid-Open No. 09-101579 by the applicant of the present application can be applied, for example.

This technique determines whether the hue of each pixel of a taken image falls within the range of a flesh color or not, and separates pixels into a flesh-color area and a non-flesh-color area. It also detects an edge in the image and classifies each portion of the image into an edge portion and a non-edge portion. Then it extracts as a face candidate area an area that is composed of pixels positioned in the flesh-color area and classified into the non-edge portion and that is enclosed by pixels determined to be the edge portion. It determines whether the extracted face candidate area is an area representing a person's face and detects it as a face area based on the result of the determination. A face area can be also detected by the method described in Japanese Patent Application Laid-Open No. 2003-209683 or No 2002-199221.

A display device 123 converts the digital image data input from the image input unit 121 to a predetermined video signal and outputs the video signal to an image projecting device, such as an LCD.

Processing blocks involved in the operations of image input, face detection, and display described above are collectively represented as an image input/reproduction system.

An operation switch 113 has a number of operation components, such as a numeric key, a direction key, and a camera switch.

A central processing unit (CPU) 112 centrally controls circuits based on input from the operation switch 113.

Memory 110 temporarily stores data necessary for processing at the CPU 112. ROM 111 is a non-volatile storage medium for permanently storing programs and firmware executed by the CPU 112.

Processing blocks involved in the operation of the CPU 112 are collectively represented as a core system.

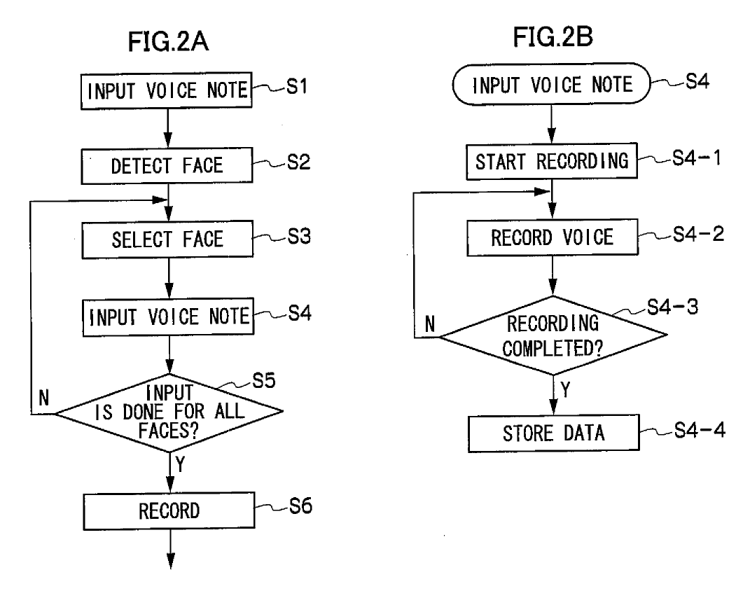

Referring to the flowcharts of FIGS. 2A and 2B, flow of recording processing performed by the information recording apparatus 10 will be described. FIG. 2A shows a main routine and FIG. 2B shows a sub-routine for voice note input. The main routine of FIG. 2A will be first described.

At S1, image data is input to the face detecting unit 122 from the image input unit 121.

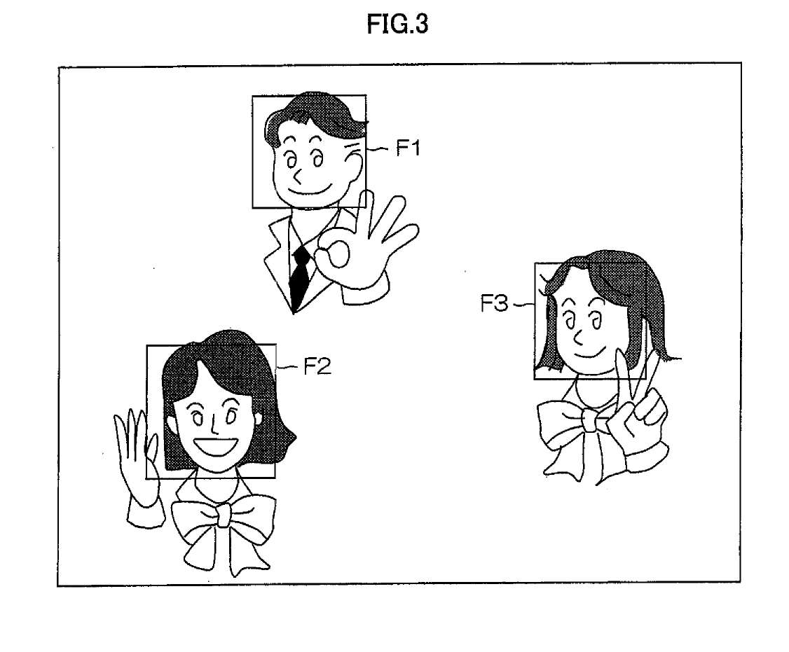

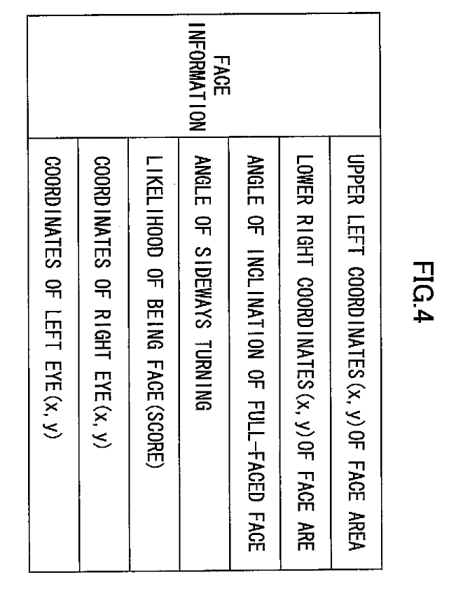

At S2, the face detecting unit 122 detects a face area from the input image data. A detected face area may also be displayed in a box on the display device 123. For example, FIG. 3 shows that three face areas F1, F2, and F3 are detected. As a result of face detection, face information including the coordinates of a face area, the angle of its inclination, the likelihood of being a face, and the coordinates of left and right eyes is stored in the memory 110 (see FIG. 4).

At S3, the CPU 112 selects a given one of the detected faces based on input from the operation switch 113.

At S4, the voice note sub-routine for accepting input of an optional voice note via the microphone 105 is executed, which will be described in more detail later.

At S5, determination is made as to whether voice notes have been input for all the detected face areas. If voice notes have been input for all the face areas, the CPU 112 proceeds to S6. If voice notes have not been input for all the face areas, the CPU 112 returns to S3.

At S6, the selected face area and the inputted voice note are recorded being associated with each other. Association of these pieces of information is performed in the following manner.

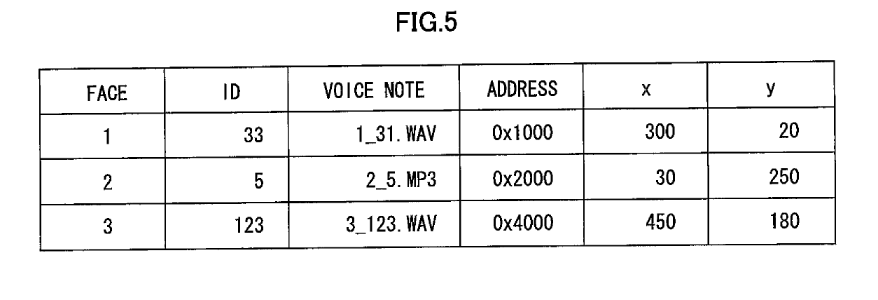

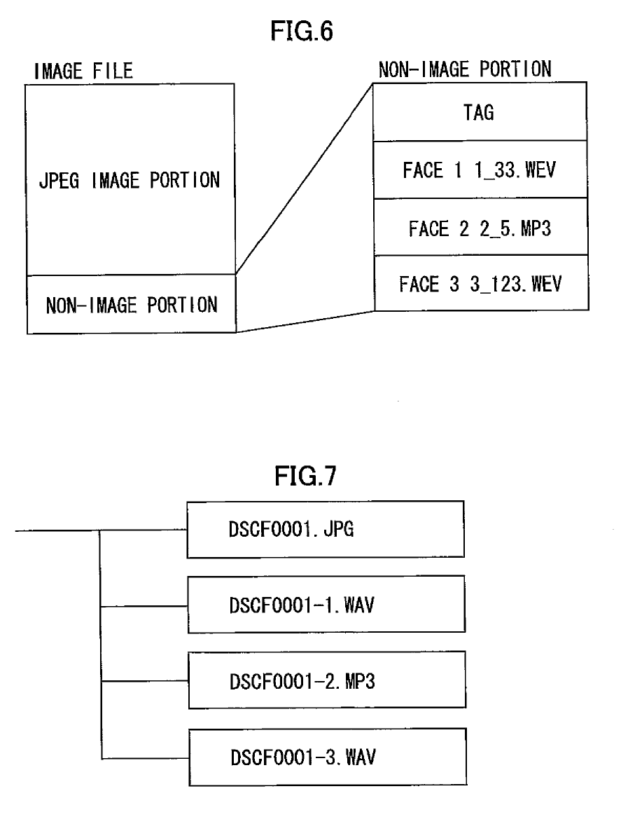

By way of example, a table is created that associates an address at which face information is stored in a non-image portion of an image file, the identification number of the face, and the position of the face area with the file name of the voice note, such as one shown in FIG. 5. Then, the table and an audio file of the voice note are recorded in the non-image portion of the image file, such as one shown in FIG. 6. The table is preferably recorded in a tag information storage portion, which is an area for storing relevant information of image information. A voice note corresponding to a face can be identified from the identification number of the face.

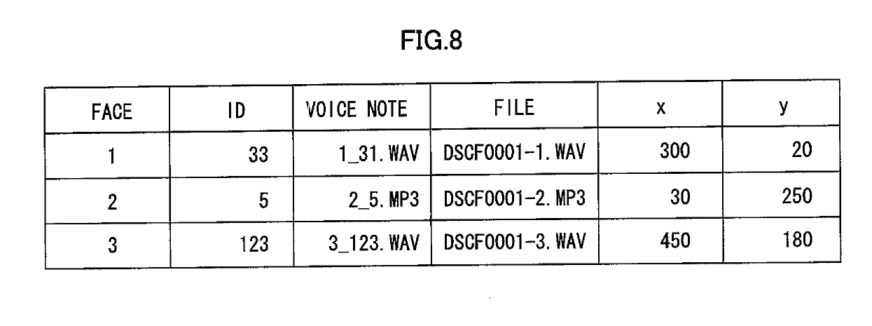

Alternatively, an audio file separate from the image file is recorded in the recording medium 76 as shown in FIG. 7. At the same time, the identification number of the face area (or face number) is included in a portion of the file name of each audio file as shown in FIG. 8. No audio file is recorded in the non-image portion of the image file.

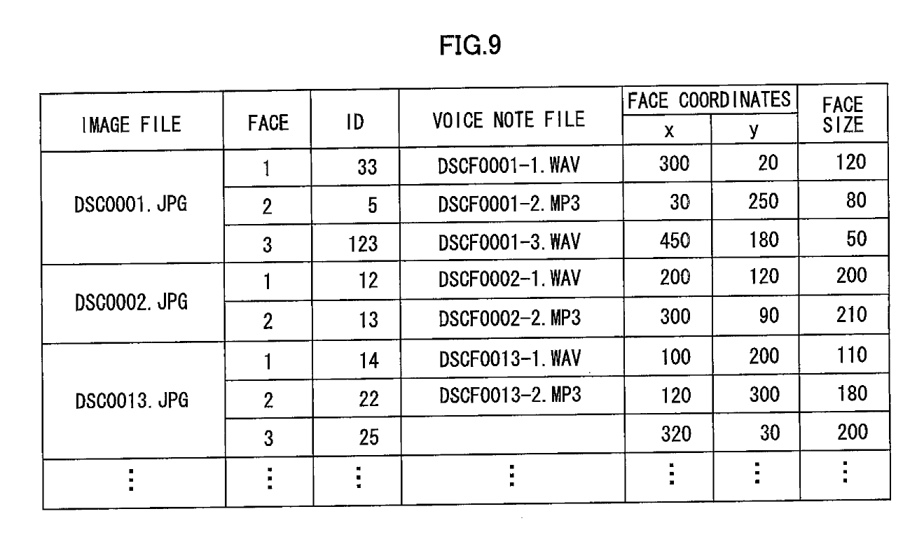

Alternatively, as shown in FIG. 9, a table itself that associates the identification information (i.e., file name) of image files and information on faces in the image files with the identification information (i.e., file name) of voice notes may be recorded in the recording medium 76 as a separate file. In this case, a table does not have to be stored in the non-image portion (tag information storing portion) of the image file.

Next, the sub-routine for voice note input of FIG. 2B will be described.

At S4-1, the CPU 112 determines whether start of voice note input has been ordered or not based on operation of the operation switch 113. If it determines that start of voice note input has been ordered, the CPU 112 instructs the A/D conversion unit 107 and the recording device 75 to start output of audio data.

At S4-2, in response to the instruction from the CPU 112, the AID conversion unit 107 converts an analog audio signal input from the microphone 105 into digital audio data and outputs the audio data to the recording device 75. Upon receipt of the audio data from the A/D conversion unit 107, the recording device 75 temporarily stores the audio data in buffer memory not shown. Then, the recording device 75 compresses the audio data stored in the buffer memory into a predetermined format and creates a voice note audio file.

At S4-3, the CPU 112 determines whether termination of voice note input has been ordered or not based on operation of the operation switch 113. If it determines that termination of voice note input has been ordered, the CPU 112 moves on to S4-4. If it determines that termination of voice note input has not been ordered, the CPU 112 returns to S4-2.

At S4-4, the CPU 112 instructs the A/D conversion unit 107 and the recording device 75 to terminate output of audio data. The recording device 75 records the voice note audio file in the recording medium 76 in accordance with the instruction from the CPU 112.

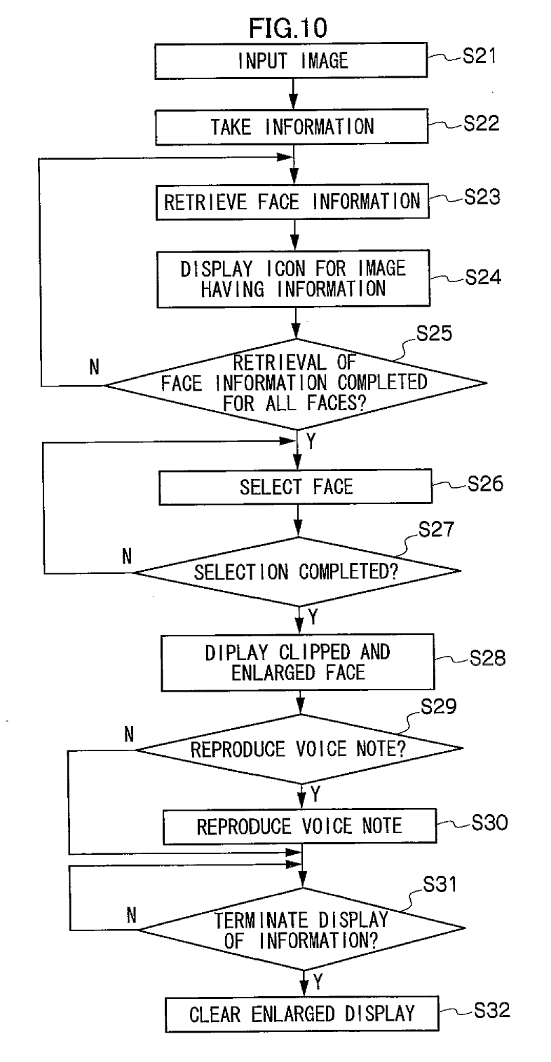

FIG. 10 is a flowchart illustrating the flow of reproduction processing.

At S21, the CPU 112 instructs the recording device 75 to read in a desired image file from the recording medium 76 in accordance with instructions from the operation switch 113. The image file read-in is stored in the memory 110.

At S22, the CPU 112 reads image data from the image portion of the image file read as well as tag information in the non-image portion of the image file.

At S23, the CPU 112 takes face information from the tag information in the non-image portion that has been read out. At the same time, the CPU 112 retrieves a voice note from the non-image portion or directly from the recording device 75.

At S24, the CPU 112 outputs to the display device 123 a composite image which places an accompanying image (a voice note mark), such as an icon and a mark, for indicating that a voice note associated with the face information has been recorded near a face area identified by the face information.

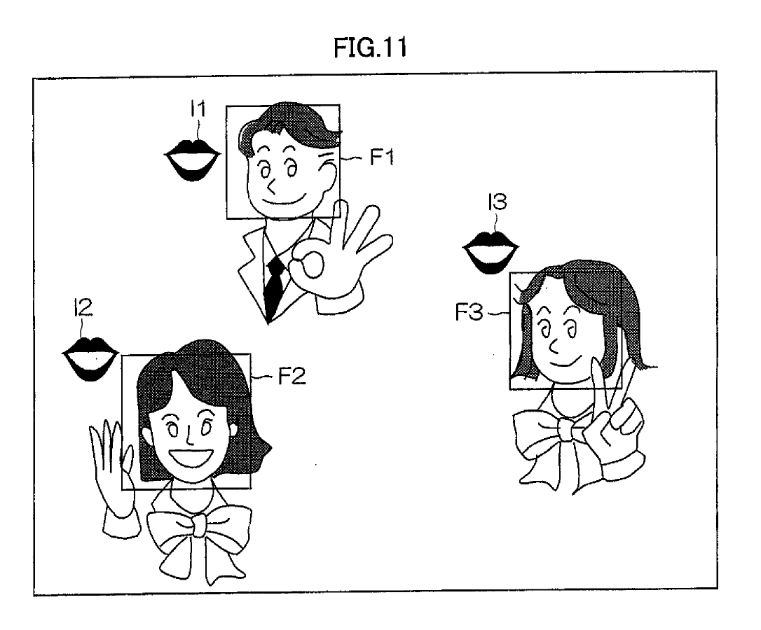

For example, as shown in FIG. 11, when voice notes are recorded for the three face areas F1, F2 and F3, voice note marks I1, I2, and I3 are superimposed being placed in the vicinity of the face areas F1, F2, and F3, respectively. From the positional relationship between the voice note marks and the face areas, it can be seen at a glance with which of the faces voice notes are associated.

At S25, the CPU 112 determines whether or not placement, superimposition and display of an accompanying image based on all face information is completed. If superimposition and display of an accompanying image are completed based on all face information, the CPU 112 proceeds to S26, otherwise, returns to S23.

At S26, the CPU 112 selects a face area for which the corresponding voice note should be reproduced in accordance with instructions from the operation switch 113.

At S27, the CPU 112 determines whether or not selection of a face area is completed in accordance with instructions from the operation switch 113. If selection of a face area is completed, the CPU 112 proceeds to S28.

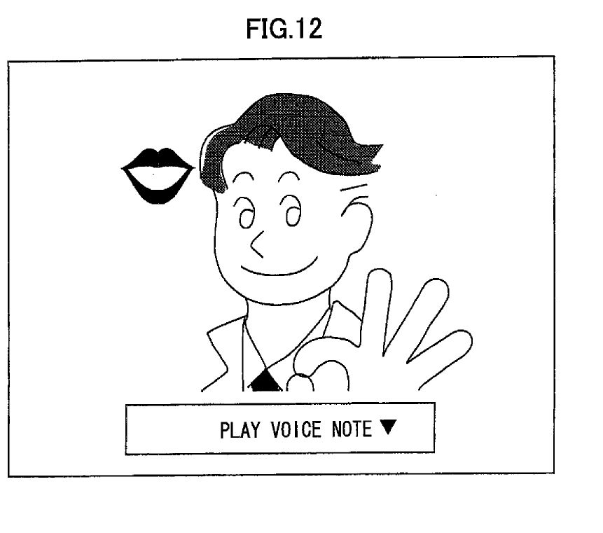

At S28, the CPU 112 clips the selected face area out of image data, enlarges it by a predetermined scaling factor (e.g., three times), and outputs it to the display device 123. By way of example, FIG. 12 shows that selected face area F1 is displayed being enlarged and with a voice note mark.

At S29, the CPU 112 determines whether or not start of reproduction of a voice note has been ordered from the operation switch 113. If start of reproduction of a voice note has been ordered, the CPU 112 proceeds to S30.

At S30, the CPU 112 identifies a voice note associated with the selected face area based on the table information retrieved at S22. Then, the audio reproducing device 102 reads out the identified voice note from the recording medium 76, converts it into an analog audio signal, and output the audio signal to the speaker 108. As a result, the contents of the voice note is played from the speaker 108.

At S31, the CPU 112 determines whether termination of enlarged display of the face area has been ordered from the operation switch 113 or not. If termination of enlarged display of the face area has been ordered, the CPU 112 proceeds to S32.

At S32, the CPU 112 terminates the enlarged display of the face area, and puts display back to one similar to display at S24.

As described above, the information recording apparatus 10 can record a meaningful message in association with a specific person in a taken image and also reproduce a specific message associated with a specific person in an image.

### Second Embodiment

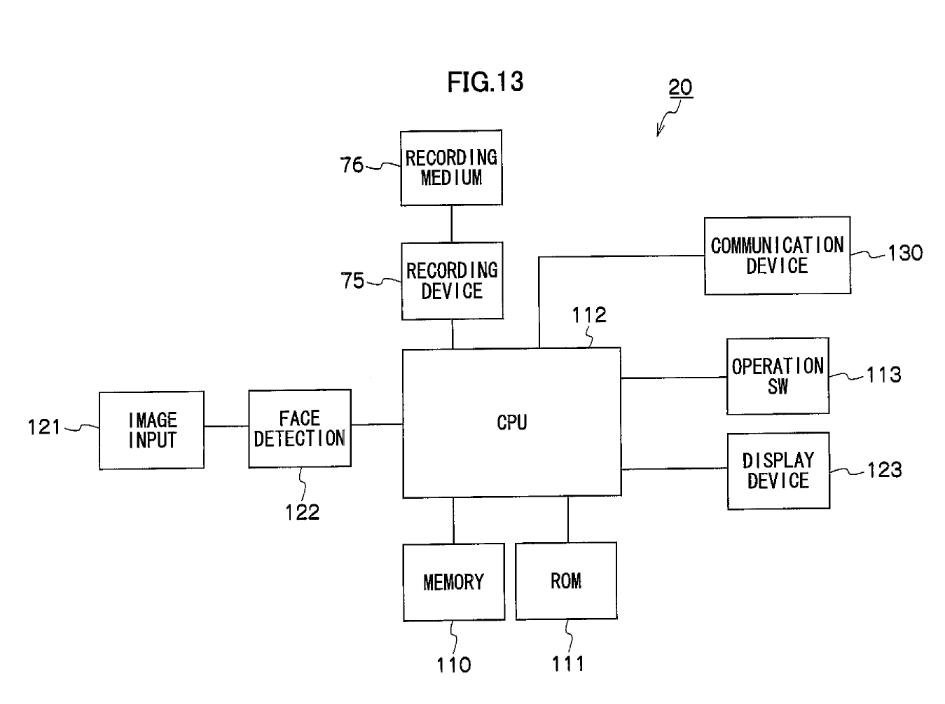

FIG. 13 is a block diagram of an information recording apparatus 20 according to a second preferred embodiment of the invention. Blocks of the information recording device 20 that have a similar function to those of the information recording apparatus 10 are designated with the same reference numeral. The information recording apparatus 20 has a communication device 130, though it does not have audio system blocks like the information recording apparatus 10.

The communication device 130 has functions of connecting to an external communication device via a communication network, such as a mobile telephone communication network and a wireless LAN, and transmitting/receiving information to/from the device.

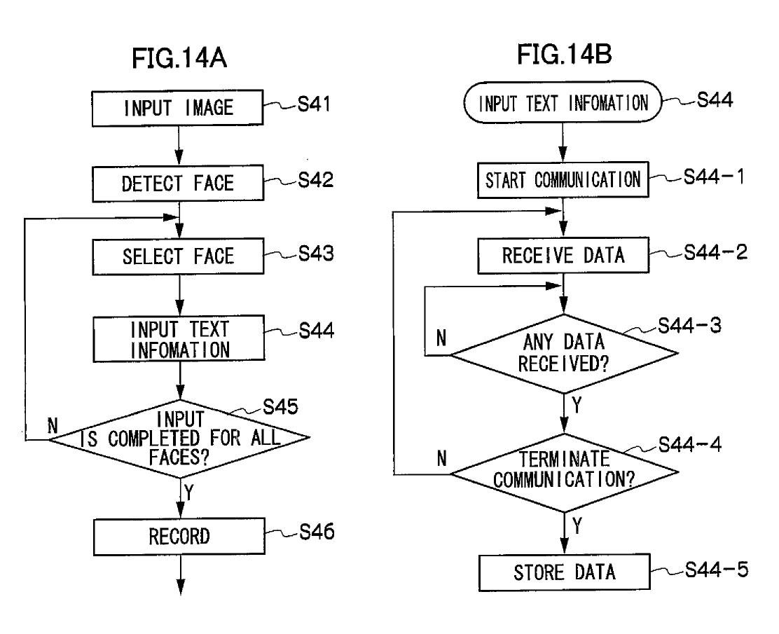

FIGS. 14A and 14B are flowcharts illustrating the flow of recording processing performed by the information recording apparatus 20. FIG. 14A shows a main routine and FIG. 14B shows a sub-routine for inputting personal business card information.

The main routine of FIG. 14A is first described.

Steps S41 to S43 are similar to S1 to S3.

At S44, the CPU 112 executes the personal business card information input sub-routine for inputting personal business card information (text information) from a communication terminal of the other party to which the communication device 130 has established a connection, which will be described in more detail later.

At S45, the CPU 112 determines whether personal business card information has been input for all face areas or not. If personal business card information has been input for all face area information, the CPU 112 proceeds to S46, if not, returns to S43.

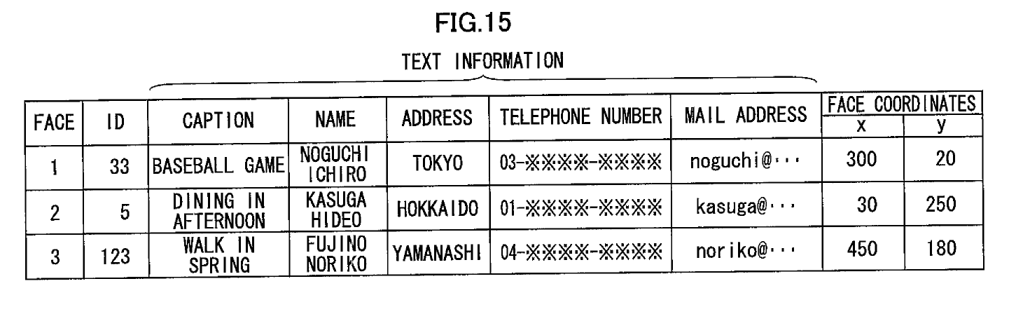

At S46, the CPU 112 records the personal business card information and a selected face area in the recording medium 76 in association with each other. Association of these pieces of information can be performed in a similar way to the first embodiment. For example, as shown in FIG. 15, a table that associates face information including identification information and position coordinates of each face area with personal business card information including caption, the user name of a communication terminal which is the sender of the personal business card information, his/her address, telephone number, mail address, and the like may be recorded in the recording medium 76 as a separate file. Alternatively, information representing this table may be recorded in the non-image portion of an image file as tag information.

The sub-routine of FIG. 14B is described next.

At S44-1, the communication device 130 establishes communication with a given party's communication terminal (e.g., a PDA, a mobile phone) designated from the operation switch 113. The party can be designated with a telephone number, for instance.

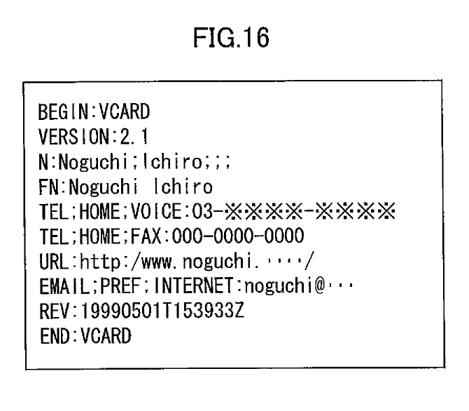

At S44-2, personal business card information (text information) is received from the other party's communication terminal. The personal business card information received from the other party's communication terminal is preferably written in a generic format. For example, it may be a text file written in Vcard (Electronic Business Card) like one shown in FIG. 16.

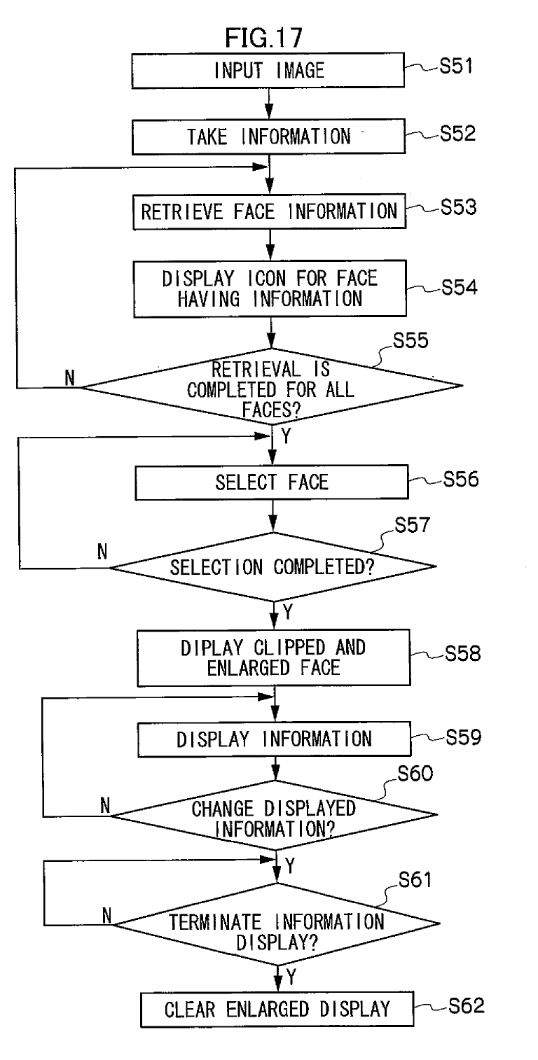

FIG. 17 is a flowchart illustrating the flow of reproduction processing performed by the information recording apparatus 20.

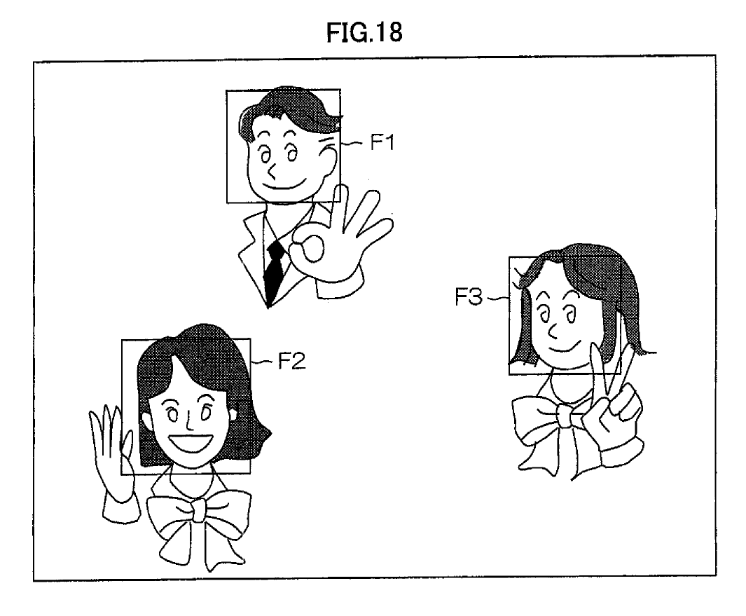

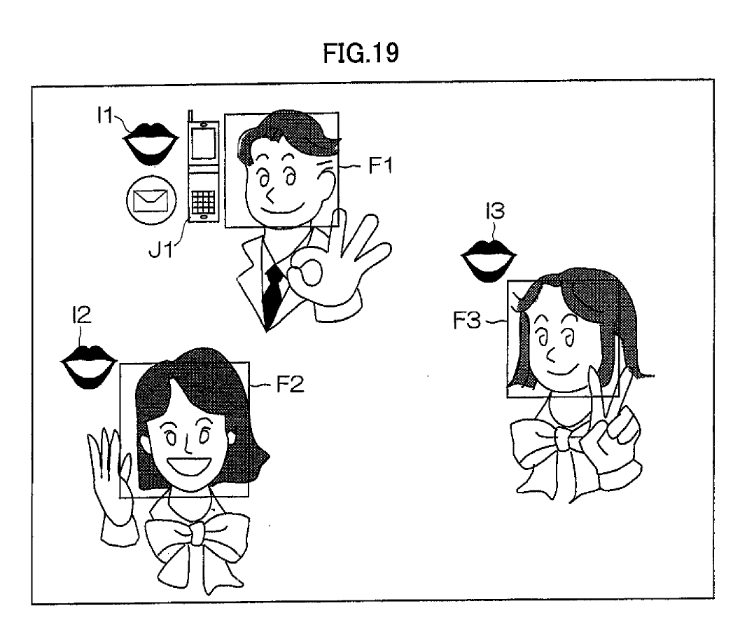

Steps S51 to S58 are similar to S21 to S28, wherein image data and so on are read out from the recording medium 76. However, what is retrieved at S53 is personal business card information, not a voice note. In addition, an accompanying image (icon) displayed at S54 is for indicating that personal business card information is associated. For example, when image data including the face areas F1 through F3 is input as shown in FIG. 18 and personal business card information is associated with face area F1, an icon J1 is superimposed near the face area F1 as shown in FIG. 19.

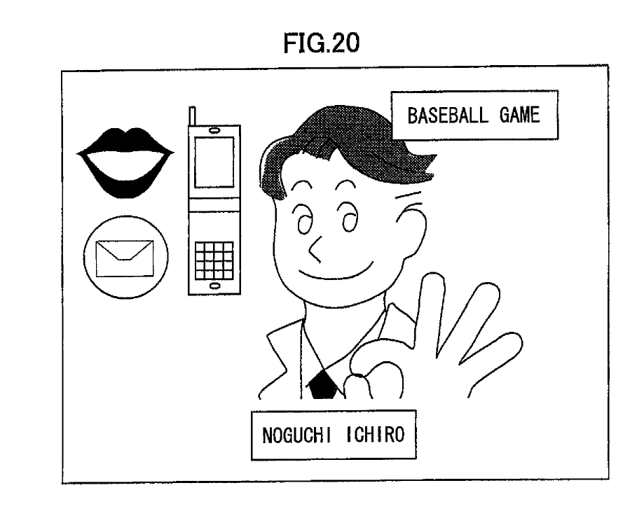

At S59, the retrieved personal business card information is superimposed onto an enlarged image of the selected face area, which is output to the display device 123. For example, when the face area F1 is selected as a face area for which corresponding personal business card information should be reproduced, the face area F1 and the icon J1 are enlarged as depicted in FIG. 20.

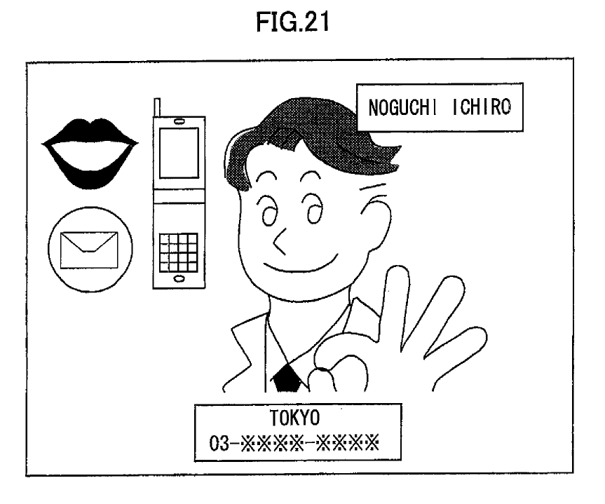

At S60, the CPU 112 determines whether or not change of detailed information items for display has been ordered. If change of detailed items of personal business card information for display has been ordered, the CPU 112 returns to S59 and displays detailed items as ordered. For example, assume that change of display to detailed items of “name”, “address” and “telephone number” is ordered when some of detailed items of personal business card information, “caption” and “name”, are displayed as shown in FIG. 20. In this case, display is changed to detailed items of “name”, “address”, and “telephone number”, as illustrated in FIG. 21. As illustrated by the figure, different detailed items (i.e., name, caption, and address) are preferably placed at different positions so that their display positions do not overlap.

Steps S61 and S62 are similar to S21 and S22, where display of personal business card information is terminated in accordance with the user's instructions.

### Third Embodiment

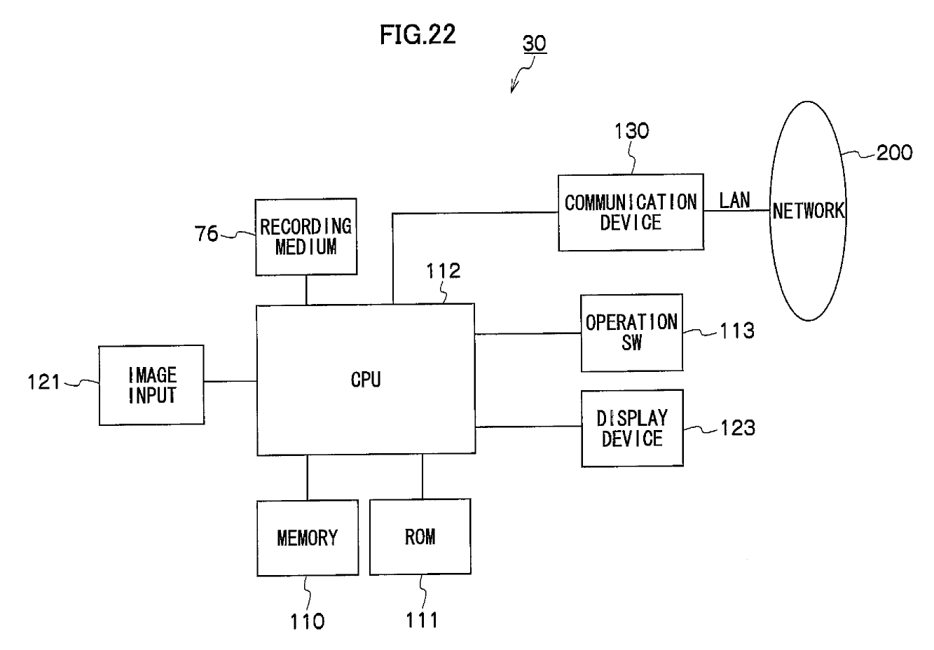

FIG. 22 is a block diagram of an information recording apparatus 30 according to a preferred embodiment of the invention. The configuration of the apparatus is similar to the second embodiment, but it does not include the face detecting unit 122. The communication device 130 is connected to an external network 200, such as the Internet, via a LAN.

The CPU 112 retrieves an image file that associates face information with address information (which is created in a similar way to the first or second embodiment) from the recording medium 76. Therefore, the face detecting unit 122 may be omitted.

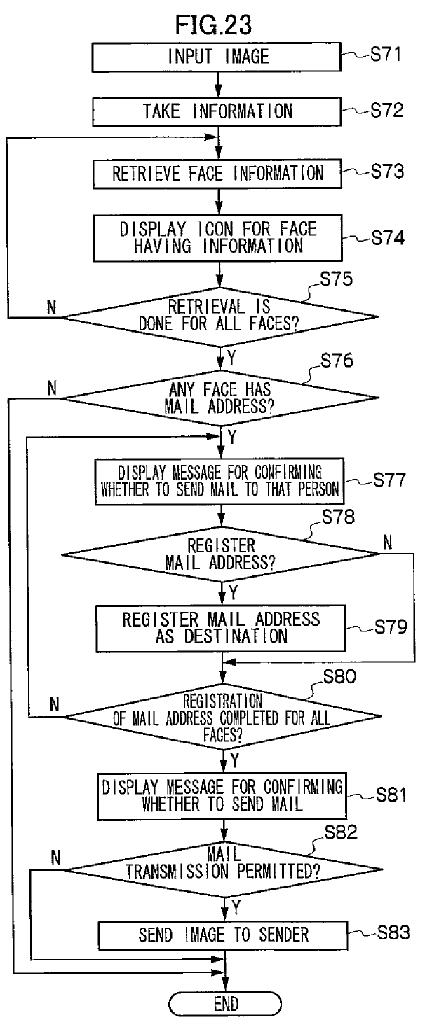

FIG. 23 is a flowchart illustrating the flow of mail transmission processing performed by the information recording apparatus 30.

At S71, the CPU 112 instructs the recording device 75 to read in a desired image file from the recording medium 76 in accordance with instructions from the operation switch 113. The read-in image file is stored in the memory 110.

At S72, the CPU 112 reads image data from the image portion of the read-in image file as well as tag information (see FIG. 15) from the non-image portion of the image file.

At S73, the CPU 112 reads face information from the tag information.

At S74, the CPU 112 superimposes an accompanying image such as an icon and a mark for indicating that a voice note has been recorded in the vicinity of the face area identified by the face information, and outputs the composite image to the display device 123 (see FIG. 11).

At S75, the CPU 112 determines whether or not superimposition and display of an accompanying image is completed based on all face information. If superimposition and display of an accompanying image is completed based on all face information, the CPU 112 proceeds to S25, and if not completed, returns to S23.

At S76, the CPU 112 determines whether or not a mail address associated with the face information is written in the tag information that was read from the recording medium 76. If a mail address associated with the face information is written in the tag information, the CPU 112 proceeds to S77.

At S77, the CPU 112 has the display device 123 display a message for prompting the user to confirm whether or not the mail address corresponding to the face information may be registered as a destination.

At S78, the CPU 112 determines whether or not the user's confirmation of whether the mail address may be registered as a destination has been input from the operation switch 113. If an instruction to register the mail address is input, the CPU 112 proceeds to S79, and if an instruction not to register it is input, the CPU 112 proceeds to S80.

At S79, the CPU 112 registers the mail address for which an instruction for permitting registration was input as a destination address for mail transmission.

At S80, the CPU 112 determines whether or not permission of registration has been confirmed for all mail addresses that were read out. If confirmation has been made for all the addresses, the CPU 112 proceeds to S81, and if there is an address not confirmed yet, the CPU 112 returns to S77.

At S81, the CPU 112 has the display device 123 display a message for prompting the user to confirm whether the image data read at S71 may be transmitted to the all registered addresses or not.

At S82, the CPU 112 determines whether or not confirmation of whether or not to transmit a mail has been input from the operation switch 113. If an instruction permitting transmission has been input, the CPU 112 proceeds to S93.

At S83, the read-in image is transmitted to all the registered mail addresses via the network 200.

With this processing, if mail addresses are associated with a number of faces contained in one image, the same image showing the owners of the faces can be automatically transmitted to those persons at a time.

A program for causing the CPU 112 to execute the above-mentioned processing represents an application for automatically transmitting an image based on mail addresses associated with faces.

### Fourth Embodiment

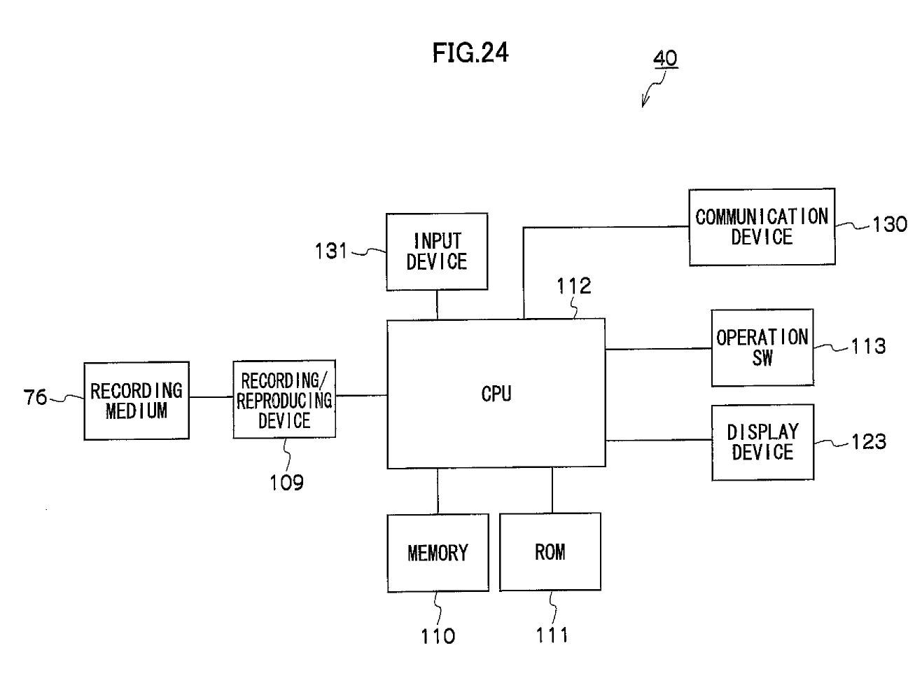

FIG. 24 is a block diagram of an information recording apparatus 40 according to a preferred embodiment of the invention. A portion of the configuration of this apparatus is similar to the first through third embodiment, but it includes a recording/reproducing device 109 and an input device 131.

The recording/reproducing device 109 converts image data read from the recording medium 76 into a video signal and outputs the video signal to the display device 123.

The input device 131 is a device for accepting input of search information which is compared with caption, name, and other personal business card information, and may be a keyboard, mouse, barcode reader, and the like, for example.

The search information does not necessarily have to be accepted from the input device 131: it may be accepted by the communication device 130 by way of a network.

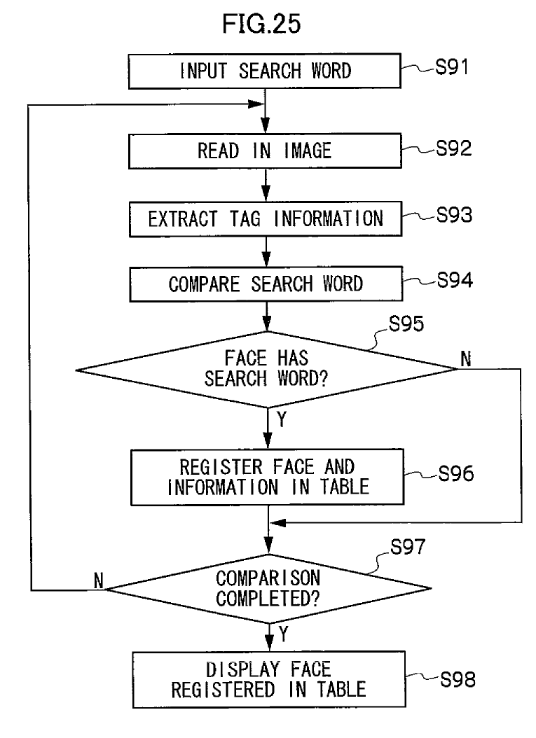

FIG. 25 is a flowchart illustrating the flow of search and display processing performed by the information recording apparatus 40.

At S91, the CPU 112 accepts input of arbitrary search information in accordance with instructions from the operation switch 113.

At S92, the CPU 112 instructs the recording device 75 to read all image files from the recording medium 76 in accordance with instructions from the operation switch 113. The read-in image files are stored in the memory 110. The CPU 112 also reads image data from the image portion of all the read-in image files as well as tag information from the non-image portion of those image files.

At S93, the CPU 112 reads personal business card information from the tag information.

At S94, the CPU 112 compares each piece of the personal business card information that was read out with the inputted search information.

At S95, the CPU 112 determines whether or not the personal business card information and the search information correspond with each other as a result of their comparison. If they correspond with each other, the CPU 112 determines that there is a face area corresponding to the search information and proceeds to S96. If they do not correspond with each other, the CPU 112 determines that there is no face area corresponding to the search information and proceeds to S97.

At S96, the CPU 112 registers the face area corresponding to the search information to a face area list.

At S97, the CPU 112 determines whether or not comparison of personal business card information with search information has been done for all the images that were read in. If comparison is completed, the CPU 112 proceeds to S98, and if not completed, returns to S92.

At S98, face areas registered in the face area list are displayed on the display device 123.

For instance, assuming that “Reunion 0831” which shows the participants of a reunion held on August 31 is input as search information, the CPU 112 identifies face areas corresponding to text information (personal information) such as captions which includes “Reunion 0831” based on a table, and extracts the images of the faces from a read-in picture of the reunion, and registers them to the face area list.

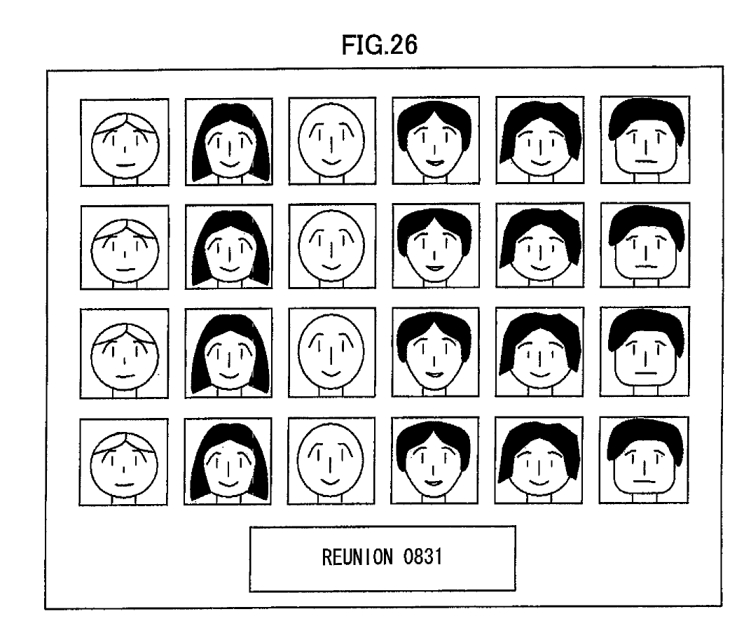

As a result, a list of people who are relevant to the “Reunion 0831” is displayed on the display device 123 as shown in FIG. 26.

In this manner, face areas associated with text information that corresponds with randomly specified search information can be automatically registered and listed.

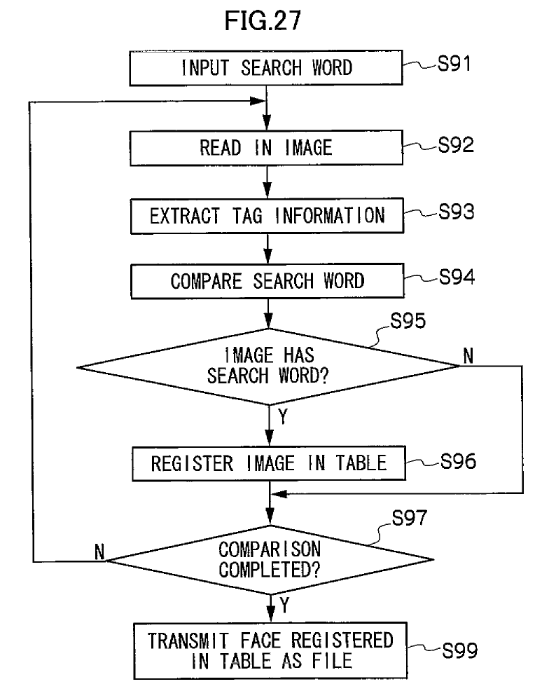

Alternatively, when search information is input (S91) to the communication device 130 via a network as shown in FIG. 27, face areas registered in the face area list or text information corresponding to the face information may be output and recorded to a separate file and the file of the face information and the text information may be transmitted (S99) to the sender of the search information, instead of displaying faces registered in the face area list on the display device 130 (S98). The recipient of the file can create an address book or a directory of people recorded in a certain image based on this file. Instead of face areas or face information, an image file itself may also be transmitted to the sender of search information.

In this manner, an image or personal information relating to information of interest can be sent back on external demand.

### Fifth Embodiment

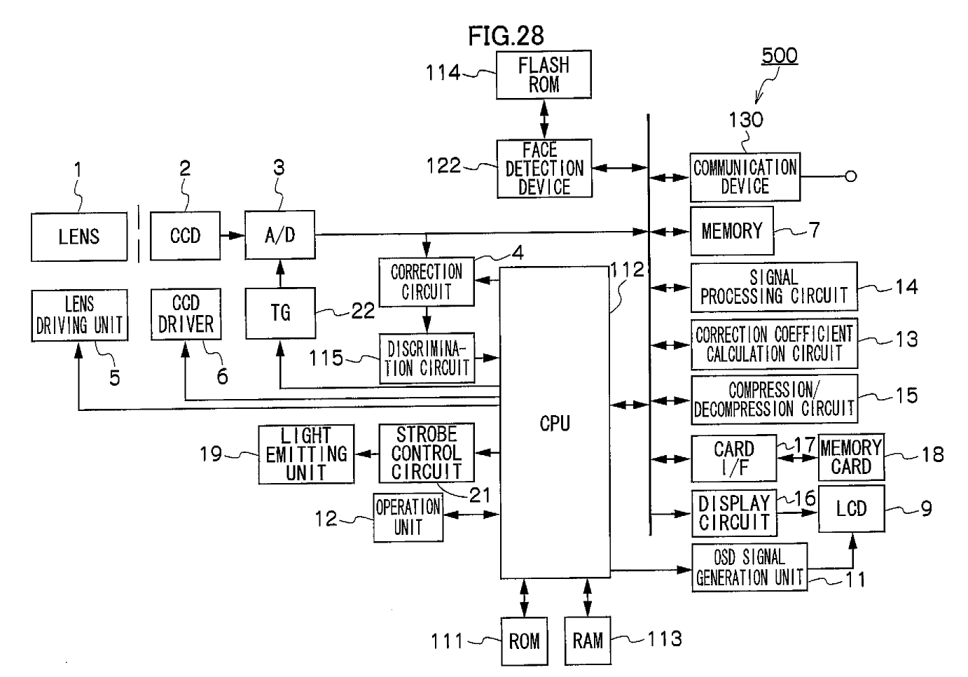

FIG. 28 is a block diagram showing the internal configuration of an image recording apparatus 500. Behind a lens I that includes a focus lens and a zoom lens, a solid-state image sensor 2 such as CCD is positioned, and light that has passed through the lens 1 is incident to the solid-state image sensor 2. On the light receiving surface of the solid-state image sensor 2, photosensors are arranged in a plane, and a subject image formed on the light receiving surface is converted by the photosensors to signal charge of an amount as a function of the amount of incident light. Signal charge thus accumulated is read out in sequence as a voltage signal (image signal) which is based on signal charge according to a pulse signal given by a driver 6, converted to a digital signal at an analog/digital conversion circuit 3 according to a pulse signal given by a TG 22, and applied to a correction circuit 4.

A lens driving unit 5 moves the zoom lens to the wide-angle side or telephoto side (e.g., 10 steps) in conjunction with zooming operations so as to perform zoom-in and -out of the lens 1. The tens driving unit 5 also moves the focus lens in accordance with subject distance and/or the variable zoom ratio of the zoom lens and adjusts the focus of the lens 1 so as to optimize shooting conditions.

The correction circuit 4 is an image processing device that includes a gain adjustment circuit, a luminance/color difference signal generation circuit, a gamma correction circuit, a sharpness correction circuit, a contrast correction circuit, a white balance correction circuit, a contour processing unit that performs image processing including contour correction to a taken image, a noise reduction processing unit for performing noise reduction processing for an image, and so forth. The correction circuit 4 processes image signals in accordance with commands from the CPU 112.

Image data processed at the correction circuit 4 is converted to a luminance signal (Y signal) and color difference signals (Cr and Cl signals) and subjected to predetermined processing such as gamma correction, then transferred to the memory 7 for storage.

When a taken image is to be output on an LCD 9, a YC signal is read from the memory 7 and sent to a display circuit 16. The display circuit 16 converts the inputted YC signal into a signal for display of a predetermined format (e.g., a color composite video signal of the NTSC method), and outputs it to the LCD 9.

The YC signal for each frame processed at a predetermined frame rate is written to A area and B area of the memory 7 alternately, and of the A area and B area of the memory 7, the written YC signal is read out from the area not the one to which the YC signal is now being written. The YC signal in the memory 7 is thus rewritten periodically and a video signal generated from the YC signal is supplied to the LCD 9 so that a picture currently being taken is displayed on the LCD 9 in real time. The user can check shooting angle with the picture displayed on the LCD 9 (or a through image).

An OSD signal generation circuit 11 generates signals for displaying characters, such as shutter speed, aperture value, the number of remaining exposures, shooting date/time, and alerting messages, as well as symbols such as icons. The signal output from the OSD signal generation circuit 11 is mixed with an image signal as necessary and supplied to the LCD 9. As a result, a composite image which superimposes pictures of characters and icons on a through image or a reproduced image is displayed.

When still picture shooting mode is selected through an operation unit 12 and a shutter button is pressed, operations of taking a still picture for recording are started. Image data obtained in response to pressing of the shutter button is subjected to predetermined processing, such as gamma correction, at the correction circuit 4 in accordance with a correction coefficient decided by a correction coefficient calculation circuit 13, and then stored in the memory 7. The correction circuit 4 may apply processing such as white balance adjustment, sharpness adjustment, and red eye correction as appropriate as the predetermined correction processing.

The Y/C signal stored in the memory 7 is compressed according to a predetermined format at a compression/decompression processing circuit 15 and then recorded to a memory card 18 via a card I/F 17 as an image file of a predetermined format, such as an Exif file. The image file may also be recorded in flash ROM 114.

On the front surface of the image recording apparatus 500, a light emitting unit 19 for emitting flashlight is provided. To the light emitting unit 19, a strobe control circuit 21 for controlling the charging and light emission of the light emitting unit 19 is connected.

The image recording apparatus 500 has the face detecting unit 122, ROM 111, RAM 113, and a discrimination circuit 115, which represent the image input/reproduction system and/or the core system described above.

The face detecting unit 122 detects a face area from obtained image data for recording in response to pressing of the shutter button. Then, the face detecting unit 122 records face information relating to the detected face area as tag information in an image file.

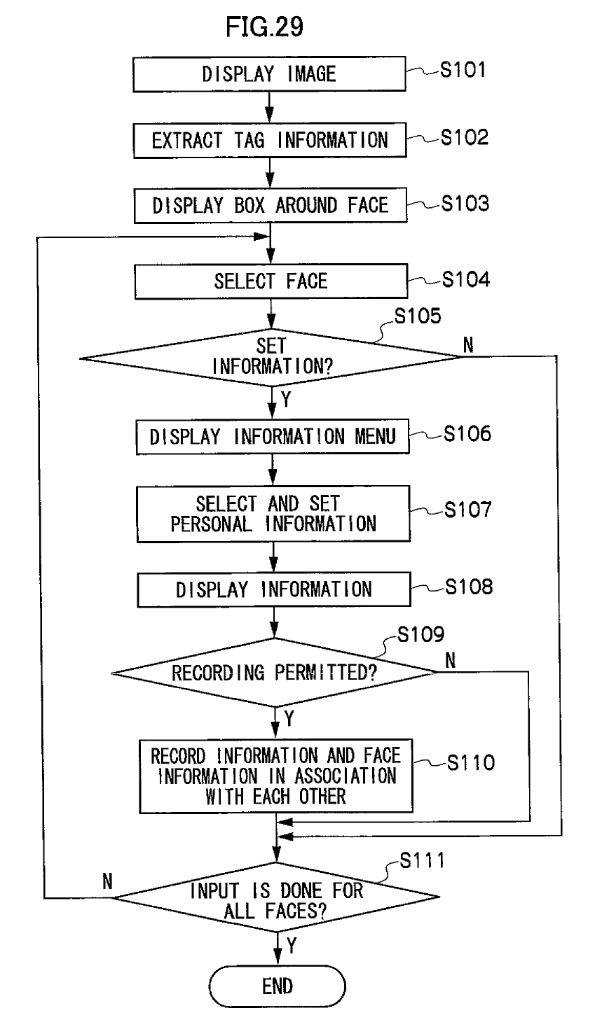

FIG. 29 is a flowchart illustrating the flow of information setting processing performed by the image recording apparatus 500.

At S101, the compression/decompression circuit 15 expands an image file in the memory card 18 or the flash ROM 14, converts it into Y/C image data, and sends it to the display circuit 16 for display on the LCD 9.

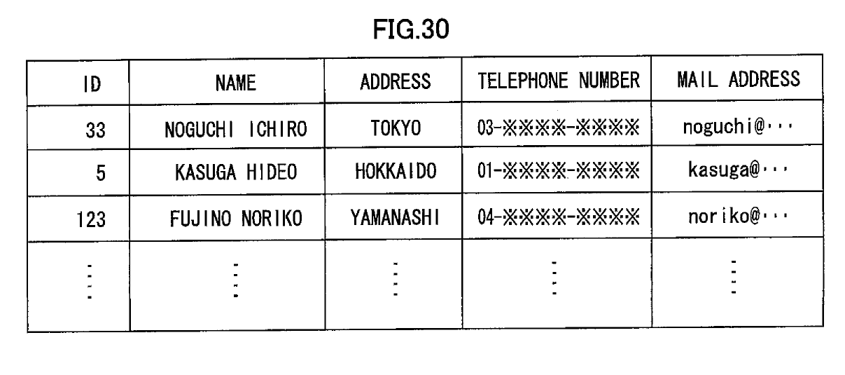

At S102, the CPU 112 input personal information from an arbitrary source of personal information, such as a terminal of the other party which is connected via the communication device 130 or the memory card 18. For example, as shown in FIG. 30, personal information is written in the form of a table that associates items such as a person's name, address, telephone number, and mail address and so on with each other. The personal information as called herein can be collected from personal business card information (see FIG. 16) which is sent from each terminal as stated above. Alternatively, it may be collected by importing personal business card information from the memory card 18.

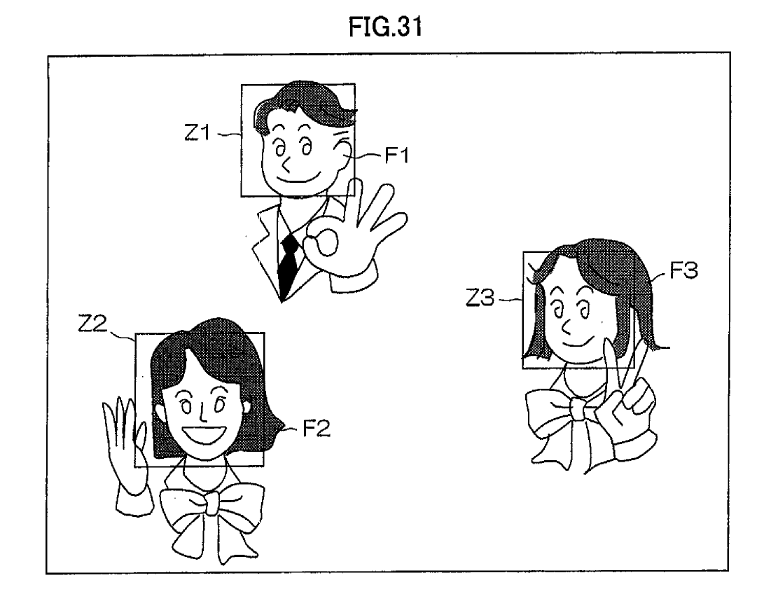

At S103, the CPU 112 takes out face information from the tag information or image data that was read out. Then, the CPU 112 controls the OSD signal generation unit 11 to display a box around each face area identified by the face information. For example, as shown in FIG. 31, when face areas F1 to F3 are detected, boxes Z1 to Z3 are displayed around the face areas.

At S104, the CPU 112 accepts selection of a given one of the face areas enclosed by the boxes via the operation unit 12.

At S105, the CPU 112 prompts the user to input confirmation of whether or not to set personal information for the selected face area. If an instruction to set personal information for the selected face area is input from the operation unit 12, the CPU 112 proceeds to S106. If an instruction not to set personal information for the selected face area is input from the operation unit 12, the CPU 112 proceeds to S111.

At S106, the CPU 112 instructs the OSD signal generation unit 11 to generate a menu for inputting personal information.

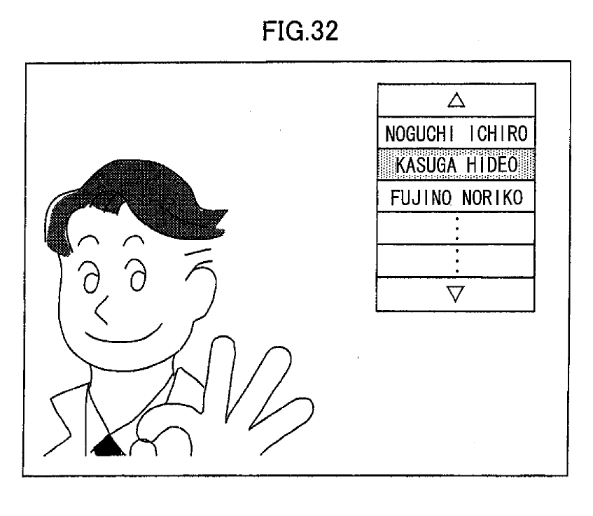

At S107, the CPU 112 accepts selection and setting of personal information via the operation unit 12. For example, as depicted in FIG. 32, a list box which lists personal information (e.g., names) read from a table is displayed by superimposition near an enlarged image of the selected face area, and the user is prompted to select a desired piece of personal information (e.g., a name) to associate with the face area from the list box.

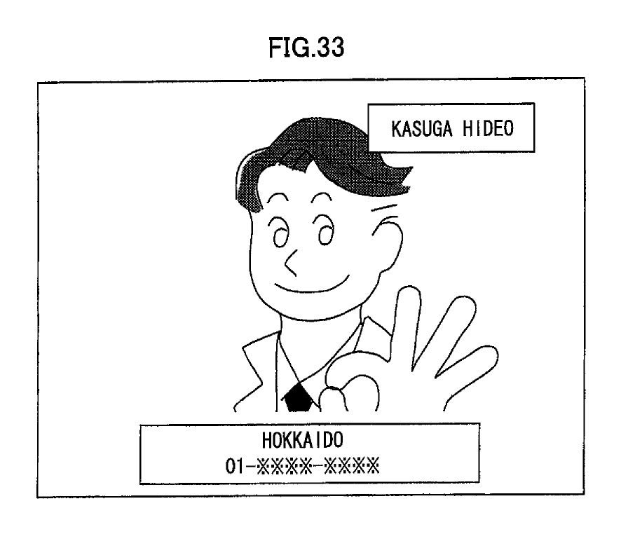

At S108, the CPU 112 instructs the OSD signal generation unit 11 to generate a video signal representing the selected personal information. In FIG. 33, for example, a selected name “Kasuga Hideo” and his address are displayed.

At S109, the CPU 112 prompts the user to input confirmation of whether or not to record the selected personal information. If an instruction to record the personal information is input from the operation unit 12, the CPU 112 proceeds to S110. If an instruction not to record the personal information is input from the operation unit 12, the CPU 112 proceeds to S111.

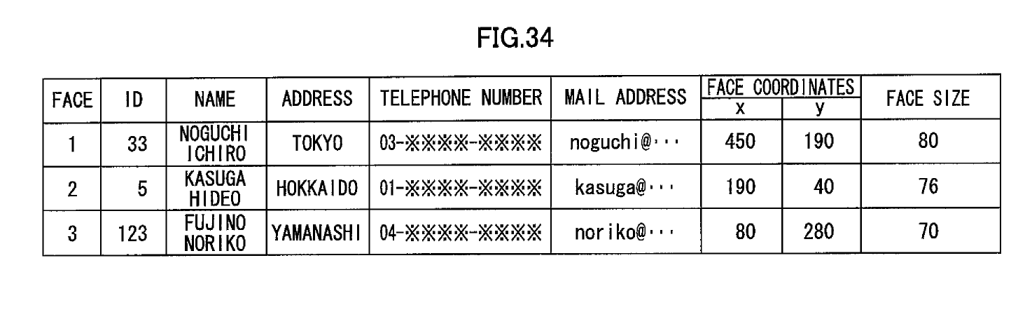

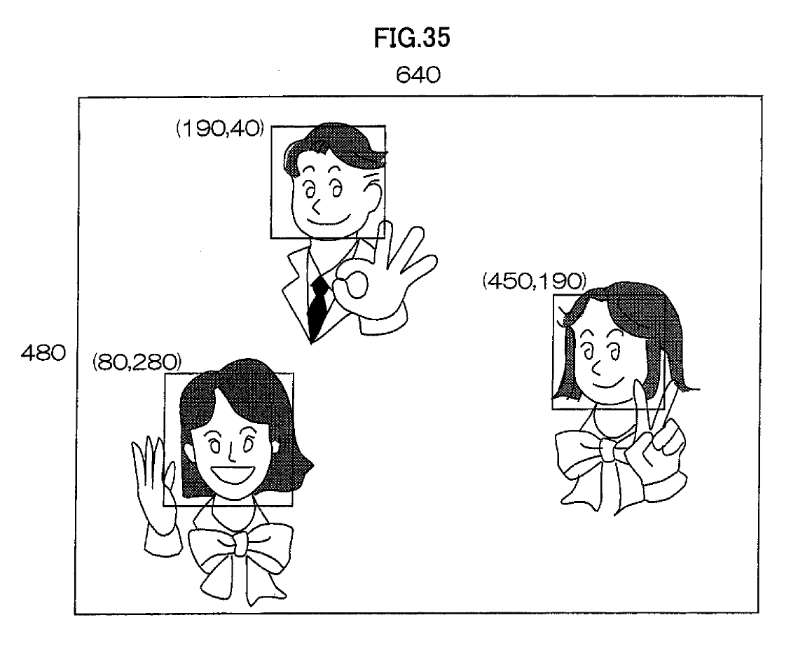

At S110, the selected personal information and the selected face information are stored in association with each other. For example, as shown in FIG. 34, the ID of the selected face area, and the reference position coordinates and the size of the face area are associated with the selected personal information in a personal information table already read in, and the table in which the personal information is associated is recorded in the tag information storage portion of an image file. As illustrated in FIG. 35, an area in which a face area is present in an image is defined by the reference position coordinates and size of the face area.

At S111, the CPU 112 determines whether or not setting of personal information is done for all face areas. If setting of personal information is not done for all face areas, the CPU 112 returns to S104. If setting of personal information is done for all face areas, the CPU 112 terminates processing.

As described above, externally input personal information can be easily associated with an arbitrary face area without taking the trouble to manually input personal information to the image recording apparatus 500.

Once personal information is associated with an image, the personal information and the image can be displayed automatically being superimposed at the time of reproduction. That is, an icon indicating that personal information is associated with a face area can be displayed near the face area based on the position coordinates of the face (see FIG. 20).

What is claimed is:

1. An information processing apparatus, comprising:
an image input unit to which an image is input;
a face detecting unit which detects a face area of a person from the image input to the image input unit;
a face-for-recording selecting unit which selects a desired face area with which a desired voice note is to be associated from among face areas detected by the face detecting unit;
a recording unit which associates a desired voice note with the face area selected by the face-for-recording unit to record the voice note;
a face-for-reproduction selecting unit which selects a desired face area from among face areas with which voice notes area is associated by the recording unit; and
a reproducing unit which reproduces a voice note associated with the face area selected by the face-for-reproduction selecting unit.

2. An information processing apparatus, comprising:
an image input unit to which an image is input;
a face detecting unit which detects a face area of a person from the image input to the image input unit;
a face-for-recording selecting unit which selects a face area with which desired relevant information is to be associated from among face areas detected by the face detecting unit;
a relevant information input unit to which desired relevant information is input;
a recording unit which associates the relevant information input to the relevant information input unit with the face area selected by the face-for-recording unit to record the relevant information;
a face-for-display selecting unit which selects a desired face area from among face areas with which relevant information is associated by the recording unit; and
a display unit which displays relevant information associated with the face area selected by the face-for-display selecting unit by superimposing the relevant information at a position appropriate for the position of the selected face area.

3. An information processing apparatus, comprising;
an image input unit to which an image is input;
a face information input unit to which face information including information identifying a face area in the image input to the image input unit is input;
an address information reading unit which reads out address information associated with the face information input to the face information input unit;
a display unit which displays the image input to the image input unit with a picture indicating that the address information is associated with the face information; and
a transmission unit which transmits the image input to the image input unit to a destination designated by the address information.

4. An information processing apparatus, comprising:
an image input unit to which an image is input;
a face information input unit to which face information including information identifying a face area in the image input to the image input unit is input;
a personal information reading unit which reads out personal information associated with the face information input to the face information input unit;
a search information input unit to which search information for retrieving desired face information is input;
a search unit which retrieves personal information that corresponds with the search information and face information that is associated with the personal information corresponding with the search information by comparing the search information input to the search information input unit with the personal information read out by the personal information reading unit; and
a list information generation unit which generates information for displaying a list of personal information and face information retrieved by the search unit.

5. An information processing apparatus, comprising:
an image input unit to which an image is input;
a face information input unit to which face information including information identifying a face area in the image input to the image input unit is input;
a relevant information input unit to which desired relevant information is input;
a face selecting unit which selects a desired face area from among face areas in the image input to the image input unit based on the face information input to the face information input unit;
a relevant information selecting unit which selects relevant information to associate with the face area selected by the face selecting unit from among pieces of relevant information input to the relevant information input unit; and
a recording unit which associates the relevant information selected by the relevant information selecting unit with the face area selected by the face selecting unit to record the relevant information.

6. An information processing method, comprising the steps of:
inputting an image;
detecting a face area of a person from the inputted image;
selecting a desired face area with which a desired voice note is to be associated from among detected face areas;
associating a desired voice note with the selected face area to record the voice note;
selecting a desired face area from among face areas with which voice notes are associated; and
reproducing a voice note associated with the selected face area.

7. An information processing method, comprising the steps of:
inputting an image;
detecting a face area of a person from the image input in the image input step;
selecting a face area with which desired relevant information is to be associated from among detected face areas;
inputting desired relevant information;
associating the relevant information input in the relevant information input step with the selected face area to record the relevant information;
selecting a desired face area from among face areas with which relevant information is associated; and
displaying relevant information associated with selected the face area by superimposing the relevant information at a position appropriate for the position of the selected face area.

8. An information processing method, comprising the steps of:
inputting an image;
inputting face information including information identifying a face area in an image input in the image input step;
reading out address information associated with the inputted face information;
displaying the inputted image with a picture indicating that the address information is associated with the face information; and
transmitting the image input in the image input step to a destination designated by the address information.

9. An information processing method, comprising the steps of:
inputting an image;
inputting face information including information identifying a face area in the image input in the image input step;
reading out personal information associated with the inputted face information;
inputting search information for retrieving desired face information;
retrieving personal information that corresponds with the search information and face information that is associated with the personal information corresponding with the search information by comparing the inputted search information with the personal information read out; and
generating information for displaying a list of retrieved personal information and face information.

10. An information processing method, comprising the steps of:
inputting an image;
inputting face information including information identifying a face area in the inputted image;
inputting desired relevant information;
selecting a desired face area from among face areas in the inputted image based on the inputted face information;
selecting relevant information to associate with the selected face area from among inputted pieces of relevant information; and
recording the selected relevant information associating the selected relevant information with the selected face area.
associating the selected relevant information with the selected face area to record the selected relevant information.
